(19) United States
(12) Patent Application Publication
(10) Pub. No.: US 2006/0081242 A1
(43) Pub. Date: Apr. 20, 2006

(54) Portable air pre-treating device for medical treatment

(76) Inventors: Tai-Kang Han, Tali City (TW); Hua Ting, Taichung (TW)

Correspondence Address: DELLETT & WALTERS, P. O. BOX 82788, PORTLAND, OR, 97282-0788, US

(21) Appl. No.: 10/942,587

(22) Filed: Sep. 15, 2004

(51) Int. Cl. A62B 7/00

(52) U.S. Cl. 128/200.24

(57) ABSTRACT

A portable air pre-treating device for medical treatment has an outer bottle with an air-heater, an inner water bag, a diverging connector, a dual tube, a venturi tube and an optional mask. The inner water bag is mounted inside the outer bottle. The diverging connector is mounted on the outer bottle to hold the inner water bag. The dual tube is attached to the diverging connector to communicate with the inner water bag and then extend to the optional mask. The venturi tube has an hourglass-shaped channel and is mounted inside the dual tube to make the air easily pick up moisture from a capillary ball when the air passes through hourglass-shaped channel. Thereby, the air is pre-heated in the outer bottle and then moisturized in the dual tube to be a suitable condition for breathing.

### BACKGROUND OF THE INVENTION

1. Field of the Invention

The present invention relates to a portable air pre-treating device for medical treatment, and more particularly to air pre-treating device that preheats the air, moisturizes the air, keeps the air at a constant pressure, and is convenient to carry.

2. Description of Related Art

The respiratory system is a vital anatomic system for breathing in human body, which includes lungs, a branched airway and other thorax tissues. The branched airway contains a trachea extending from the pharynx and passes through the larynx after which it branches into the lungs and gradually diverges into smaller and smaller airways such as bronchi, branch bronchi, small bronchi and terminal bronchi in the lungs. Multiple alveolus are formed on the terminal bronchi to exchange gases in the lungs.

Respiratory disorders often result in a person being unable to take in enough air to allow sufficient oxygen transfer to the blood or to sufficiently scrub carbon dioxide from the blood. Several reasons cause insufficient breathing. For example, asthma constricts the airway and restricts the air entering the lungs. Serious asthma attacks may cause a person to go into shock and put a person's life in imminent danger. Since the respiratory system also provides protection from external factors such as bacteria, dust, toxic gases, etc., patients need an air pre-treating device to augment or substitute for the lungs to carry out the protection when the respiratory system is not working very well.

Conventional air pre-treating devices (respirators) are only in hospitals or other sanatoriums for smokers or patients having allergic respiratory, hypersensitive rhinitis because impure air easily damages their lungs. Therefore, the air pre-treating device is mostly used as an auxiliary device in medical treatment.

However, the conventional air pre-treating device is cumbersome and inconvenient to operate so the conventional air pre-treating device is non-portable. In some special situations such as when patients are out of the hospital, the conventional air pre-treating device cannot be taken with them for medical treatment. In other special situations such as mountain climbers at high altitudes, cold and dry air on the mountains eventually causes pulmonary lesions in mountain climbers, which lead to edema and may result in death. Therefore, mountain climbers need the air pre-treating device to condition the air for breathing, but the conventional air pre-treating device cannot be used to do this because it is not portable.

The present invention has arisen to mitigate or obviate the disadvantages of the conventional air pre-treating device for medical treatment.

### SUMMARY OF THE INVENTION

The objective of the present invention is to provide a portable air pre-treating devices that is convenient to use.

The air pre-treating device in accordance with the present invention achieves the foregoing objective and comprises an outer bottle, an inner water bag, a diverging connector, a dual tube with a venturi tube. The outer bottle has an air-heater and a filter. The inner water bag is mounted inside the outer bottle. The diverging connector is mounted on the outer bottle to hold the inner water bag via a tube. The dual tube is mounted on the diverging connector. The venturi tube has a capillary ball and is mounted inside the dual tube to allow the air to absorb moisture from the capillary ball. Thereby, the air is pre-heated in the outer bottle and moisturized in the dual tube to condition the air properly for breathing.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a portable air pre-treating device for medical treatment in accordance with the present invention;

FIG. 2 is an enlarged exploded perspective view in partial cross-section of the air pre-treating device in FIG. 1;

FIG. 3 is an enlarged exploded perspective view of an air-heater in the air pre-treating device in FIG. 2;

FIG. 4 is an enlarged cross-sectional side view of a diverging connector of the air pre-treating device in FIG. 2; and

FIG. 5 is an enlarged cross-sectional side view of a mask nozzle of the air pre-treating device in FIG. 1.

### DETAILED DESCRIPTION OF THE PREFERRED EMBODIMENT

A portable air pre-treating device for medical treatment in accordance with the present invention comprises an outer bottle, an inner water bag, a diverging connector, a dual tube and an optional mask. The outer bottle has an air-heater, and the inner water bag is mounted inside the outer bottle. The diverging connector is mounted on the outer bottle to hold the inner water bag. The dual tube is attached to the diverging connector to communicate with the inner water bag, extends to the optional mask and has a venturi tube with a capillary ball. The venturi tube has an hourglass-shaped channel and is mounted inside the dual tube to allow the air in the dual tube to pick up moisture from the capillary ball as the air passes through the hourglass-shaped channel. Thereby, the air is pre-heated in the outer bottle and then moisturized in the dual tube to a suitable condition for breathing.

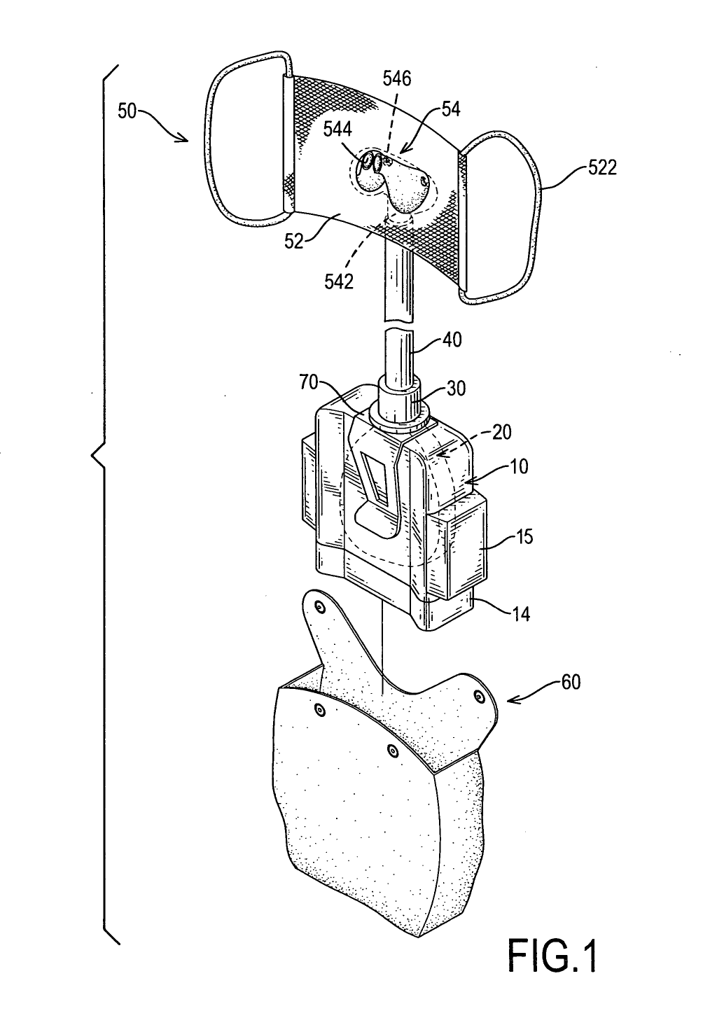

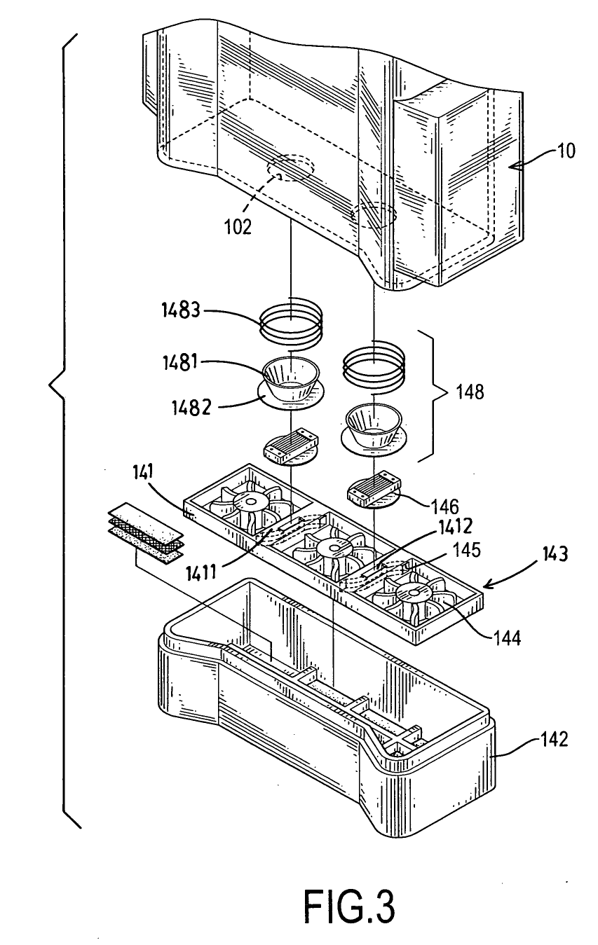

With reference to FIGS. 1 to 3, a preferred embodiment of the portable air pre-treating device for medical treatment comprises an outer bottle (10), an inner water bag (20), a diverging connector (30), a dual tube (40), an optional mask (50), an optional jacket (60) and an optional clip (70).

The outer bottle (10) has a top opening (12), a bottom with multiple through holes (102), two sides, a thermal conditioning unit (14) and two rechargeable batteries (15).

The top opening (12) has a longitudinal flange (122) and an external thread formed around the longitudinal flange (122).

The bottom has two through holes (102). Each through hole (102) has a diameter.

The thermal conditioning unit (14) has a base (142), an optional fan assembly (143), two heating elements (146), two check valves (148) and three optional filters ( ).

The base (142) is attached to the bottom of the outer bottle (10) around the through holes (102) and has an open top, a bottom and an internal chamber. The open top is connected to the bottom of the outer bottle (10). The bottom has multiple openings that serve as air inlets.

The fan assembly (143) is mounted in the base (142) and comprises a fan chassis (141) and multiple induction fans (144). The fan chassis (141) is mounted in the internal chamber of the base (142) and has multiple sections and multiple division walls (1411). Each division wall (1411) has a top, two sides and an air passage. Each air passage has two air inlets (145) and an air outlet (1412). The two air inlets (145) for each division wall (1411) are formed respectively in opposite sides of the division wall (1411) and communicate respectively with the adjacent sections. The air outlet (1412) is formed in the top of the division wall (1411) and communicates with the air inlets (145). The induction fans (144) are mounted respectively in the sections of the fan chassis (141) and blow air respectively into the corresponding air inlets (145), through the air passages, out the outlets (1412) and through the two through holes (102) of the outer bottle (10).

The two heating elements (146) are mounted in the cavity in the base (142) and correspond respectively to and align with the two through holes (102) in the base (142). When the fan assembly (143) is included, the heating elements (146) are mounted respectively over the air outlets (1412) in the division walls (1411) in the fan chassis (141).

The check valves (148) are mounted respectively between the heating elements (146) and the through holes (102) of the outer bottle (10) to prevent air from flowing back into the base (142). Each check valve (148) comprises a tapered body (1481) with a bottom flange (1482) and a spring coil (1483). The tapered body (1481) has a maximum diameter, a minimum diameter, an inside end and an outside end. The maximum diameter is at the inside end and is larger than the diameter of the through holes (102) in the bottom of the outer bottle (10). The inside end is mounted inside the outer bottle (10) so the tapered bodies (1481) will engage and close the through holes (102) in the outer bottle (10). The spring coil (1483) is mounted around the tapered body (1481) between the bottom of the outer bottle (10) and the bottom flange (1482) to keep the check valves (148) closed until air pressure in the base (142) forces air into the outer bottle (10).

The three filtering elements are a bottom filter, a middle filter and a top filter and are mounted inside the multiple openings in the bottom of the base (142). The bottom filter is a compressed mixture of active carbon particles, potassium permanganate particles and zeolit particles and removes organic compounds from the air entering the base (142). The middle filter is irregular glass fiber to further remove dust and mites. The top filter is active carbon to further remove particles from the air.

The two rechargeable batteries (15) are attached respectively to the two sides of the outer bottle (10) to supply electricity to the induction fans (144) in the fan assembly (143) and the heating elements (146).

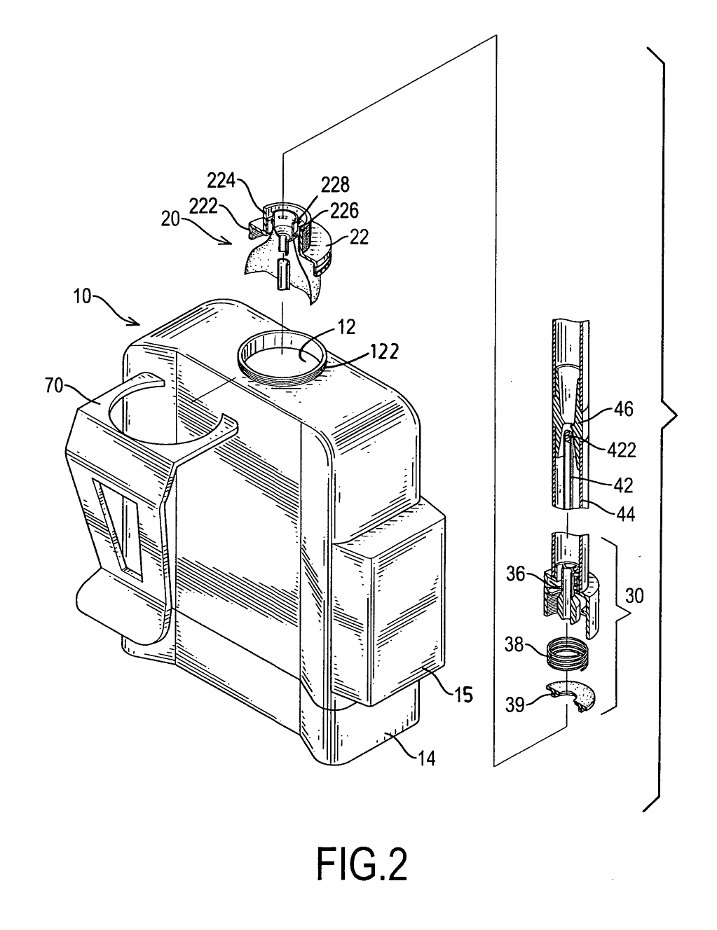

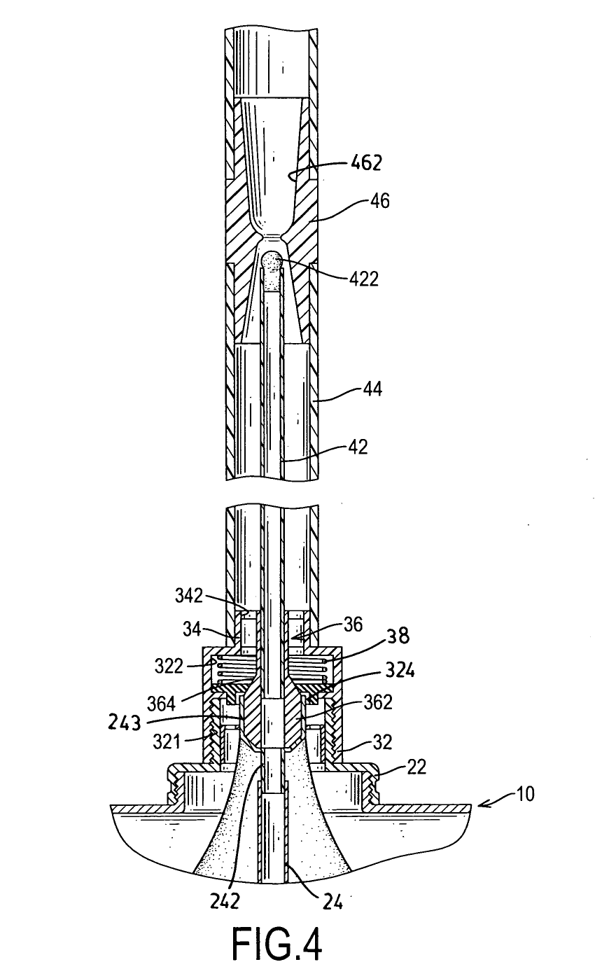

With particular reference to FIGS. 2 and 4, the inner water bag (20) is a pliable bag, is mounted inside the outer bottle (10) and has an opening, a rigid connector (22) and a resilient pick-up tube (24). The rigid connector (22) detachably engages the longitudinal flange (122) on the outer bottle (10) and has a top face, a bottom face, a through tube (242), a lower longitudinal flange (222), an upper longitudinal flange (224) and multiple gas holes (228). The lower longitudinal flange (222) is formed on the bottom face of the rigid connector (22). The lower longitudinal flange (222) screws onto the external thread of the top opening (12) of the outer bottle (10). The upper longitudinal flange (224) has an annular flange (226) and an inner surface and is formed on the top face of the rigid connector (22) to detachably engage the diverging connector (30). The annular flange (226) extends from an inner surface of the upper longitudinal flange (224) and connects to the through tube (242). The through tube (242) is longitudinally formed in the rigid connector (22) and has an enlarged funnel-shaped proximal end (243) and a distal end. The funnel-shaped proximal end (243) is connected to the annular flange (226). The multiple gas holes (228) are defined through the annular flange (226) to allow air to flow through the gas holes (228).

The resilient pick-up tube (24) is detachably connected to the distal end of the through tube (242) and extends into the inner water bag (20) so that the through tube (242) and the resilient pick-up tube (24) form a water channel.

The diverging connector (30) is mounted on the rigid connector (22) and comprises a lower portion (32), an upper portion (34), a middle tube (36) and a check valve assembly.

The lower portion (32) has a bottom edge, a threaded chamber (321), a valve chamber (322) and a dividing wall. The treaded chamber (321) is formed near the bottom edge and has a threaded inner surface to engage the upper longitudinal flange (224) of the rigid connector (22). The valve chamber (322) is formed over the threaded chamber (321). The dividing wall is formed between the threaded chamber (321) and the valve chamber (322) and has a central hole (324) so the threaded chamber (321) and the valve chamber (322) communicate with each other.

The upper portion (34) is integrally formed on the lower portion (32) and has multiple longitudinal passages (342) defined through the upper portion (34).

The middle tube (36) has an enlarged distal end (362), is formed axially in the diverging connector (30), penetrates the central hole (324) in the dividing wall and longitudinally extends through the upper portion (34) and the lower portion (32). The enlarged distal end (362) has an inclined top face (364) and corresponds to and engages the enlarged funnel-shaped end of the through tube (242).

The check valve assembly is mounted inside the valve chamber (322) and comprises a spring (38) and an annular diaphragm (39). The spring (38) and the annular diaphragm (39) abut the middle tube (36) in the valve chamber (322). The annular diaphragm (39) is mounted under and pushed by the spring (38) to block the central hole (324). Particularly, the annular diaphragm (39) abuts the inclined top face (364) on the enlarged distal end (362) of the middle tube (36). Therefore, when gas pressure inside the outer bottle (10) presses the check valve assembly, the annular diaphragm (39) moves upward, disengages from the inclined top face (364) and forms a gap between the annular diaphragm (39) and the middle tube (36) to allow air to unidirectionally flow through the gap.

The dual tube (40) extends between the diverging connector (30) and the mask (50) and is composed of an inner tube (42), an outer tube (44) and a venturi tube (46).

The outer tube (44) has a proximal end and a distal end. The proximal end is attached to the upper portion (34) of the diverging connector (30).

The venturi tube (46) is attached to the distal end of the outer tube (44) and has an hourglass-shaped channel (462) defined longitudinally inside the venturi tube (46). The hourglass-shaped channel (462) has a restricted air passage half way through the hourglass-shaped channel (462).

The inner tube (42) has a proximal end, a distal end and a capillary ball (422). The proximal end is connected to the middle tube (36) of the diverging connector (30), and the distal end extends into the venturi tube (46). The capillary ball (422) is mounted on the distal end of the inner tube (42) inside the venturi tube (46) near the restricted air passage. When air passes through the venturi tube (46), the air increases speed as it approaches the restricted air passage and passes the capillary ball (422) where it picks up water molecules from the capillary ball (422) and moisturizes the air.

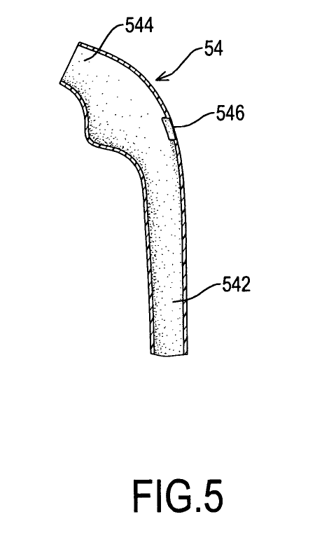

With further reference to FIG. 5, the mask (50) comprises a cover (52) and a tubular integrator (54). The cover (52) is made of cloth and has two side ends and two elastic strings (522) attached respectively to the two side ends to mount the mask (50) on a patient's face. The tubular integrator (54) is mounted inside the cover (50) and comprises a front face, a rear face, an inlet tube (542), two inhaling tubes (544) and two outlets (546). The inlet tube (542) extends out of the cover (52) and connects and communicates with the dual tube (40). The two inhaling tubes (544) extend from the rear face behind the cover (52) and are inserted into a patient's nasal passages. The two outlets (546) are formed on the front face. Each outlet (546) is a membrane with a cross-shaped cut opening to release air when the air pressure is too high. The inlet tube (542), the two inhaling tubes (544) and the two outlets (546) are integrally and smoothly combined together to compose the tube integrator (54) so that the air flows smoothly into the patient's nasal passages without causing any turbulence. The membrane keeps the air pressure inside the tube integrator (54) above a constant value to make the treated air enter the patient's nasal passage. Therefore, the pumping system (such as motor fans) can save power in keeping the pressure constant. When the patent exhales, the air pressure is risen and then air flows out through the outlets (546).

Preferably, the outer bottle (10) is mounted in a thermal insulating jacket (60) to keep the temperature of the air pre-heating device from dropping quickly. Additionally, a C-neck clip (70) is detachably attached to the longitudinal flange around the opening (12) of the outer bottle (10) so that the air pre-heating device is convenient to carry.

When the portable air pre-heating device operates, the air-heater and the induction fans (144) are actuated to force air through the thermal conditioning unit (14) and the heating elements (146) to clean and warm up the air before the air enters the outer bottle (10). The air passes through the central hole (324) and the passages (342) in the diverging connector (30) and then pass through the dual tube (40) to enter the mask (50). When the air enters the outer bottle (10), air pressure in the outer bottle (10) increases and squeezes the inner water bag (20), which forces warm water in the inner water bag (20) into the resilient pick-up tube (24), the middle tube (36) in the diverging connector (30) and the inner tube (42) of the dual tube (40) to the capillary ball (422). Thereby, the treated air contacts the capillary ball (422) in the hourglass-shaped channel in the venturi tube (46) to increase the moisture in the air.

Additionally, when the mask (50) operates, the inlet tube (542), the two inhaling tubes (544) and the two outlets (546) are integrally combined together in the tube integrator (54) so that mask (50) can be conveniently achieved by attaching the tube integrator (54) to the cover (52).

According to above description, the air pre-treating device has the following advantages:
1. The air pre-treating device is formed in a small bottle and is conveniently portable to use anywhere, even in the mountains

2. The air pre-treating device cleans and preheats the air in the outer bottle (10) and moisturizes the air in the venturi tube (46) so that the air is adjusted to a proper condition for breathing.

Although the invention has been explained in relation to its preferred embodiments, many other possible modifications and variations can be made without departing from the spirit and scope of the invention as hereinafter claimed.

What is claimed is:

1. A portable air pre-treating device for medical treatment comprising:
an outer bottle (10) having
a top opening (12);
a bottom with multiple through holes (102);
two sides;
a thermal conditioning unit (14) having a base (142) attached to the bottom of the outer bottle (10) around the through holes (102) and having an open top connected to the bottom of the outer bottle (10), a bottom with multiple openings, and an internal chamber; and
two rechargeable batteries (15) attached respectively to the sides;
an inner water bag (20) mounted inside the outer bottle (10) and having
an opening; and
a rigid connector (22) attached around the opening of the inner water bag (20) to detachably mount the inner water bag (20) on the outer bottle (10) and having a through tube (242), an annular flange (226) extending from and around the through tube (242), multiple gas holes (228) defined in the annular flange (226) and a pick-up tube (24) connected with the through tube (242) to extend into the inner water bag (20);
a diverging connector (30) mounted on the rigid connector (22)
and comprising:
a lower portion (32) having
a threaded chamber (321) engaging the rigid connector (22);
a valve chamber (322) formed over the threaded chamber (321); and
a dividing wall formed between the threaded chamber (321) and the valve chamber (322) and having a central hole (324) so that the threaded chamber (321) and the valve chamber (322) communicate with each other;
wherein the valve chamber (322) has a check valve assembly mounted inside the valve chamber (322);
an upper portion (34) formed on the lower portion (32) and communicating with the lower portion (32); and
a middle tube (36) formed axially in the diverging connector (30), penetrating the central hole (324) in the dividing wall and extending longitudinally through the upper portion (34) and the lower portion (32);
a dual tube (40) connected to the diverging connector (30) and comprising:
an outer tube (44) having a proximal end attached to the upper portion (34) of the diverging connector (30) and a distal end;
a venturi tube (46) attached to the distal end of the outer tube (44) and having an hourglass-shaped channel (462) defined longitudinally inside the venturi tube (46), which has a restricted air passage half way through the hourglass-shaped channel (462); and
an inner tube (42) having a proximal end connected to the middle tube (36) of the diverging connector (30), a distal end and a capillary ball (422) mounted on the distal end of the inner tube (42) inside the venturi tube (46) near the restricted air passage;
wherein, the thermal conditioning unit (14) further comprises:
multiple filters;
a fan assembly (143) mounted inside the internal chamber in the base (142);
multiple heating elements (146) mounted over the fan assembly (143) inside the base (142); and
multiple check valves (148) mounted over the heating elements (146) and engaging the through holes (102) in the bottom of the outer bottle (10).

2. The portable air pre-treating device as claimed in claim 1, wherein the check valve assembly in the diverging connector (30) comprises:
a spring (38) mounted inside the valve chamber (322) around the middle tube (36); and
an annular diaphragm (39) surrounding the middle tube (36) under the spring (38) and pressed by the spring (38) to block the central hole (324) around the middle tube (36); and
the middle tube (36) further has an enlarged distal end (362) with an inclined top face (364) to make the annular diaphragm (39) abut the inclined top face (364).

3. The portable air pre-treating device as claimed in claim 1, wherein the check valve assembly in the diverging connector (30) comprises
a spring (38) accommodated inside the valve chamber (322) around the middle tube (36); and
an annular diaphragm (39) surrounding the middle tube (36) under the spring (38) and pressed by the spring (38) to block the central hole (324) around the middle tube (36); and
the middle tube (36) further has an enlarged distal end (362) with an inclined top face (364) to make the annular diaphragm (39) abut the inclined top face (364).

4. The portable air pre-treating device as claimed in claim 3, wherein the portable air pre-treating device further comprises:
a jacket (60) in which the outer bottle (10) is mounted to provide thermal insulation; and
a C-neck clip attached to the outer bottle (10).
